(19) United States
(12) Patent Application Publication
(10) Pub. No.: US 2019/0024980 A1
(43) Pub. Date: Jan. 24, 2019

(54) DUCT SYSTEM WITH INTEGRATED WORKING PLATFORMS

(71) Applicant: AMERIFAB, INC., Indianapolis, IN (US)

(72) Inventors: Richard Manasek, Carmel, IN (US); Gabriele Carinci, Indianapolis, IN (US)

(21) Appl. No.: 16/033,862

(22) Filed: Jul. 12, 2018

Related U.S. Application Data
(60) Provisional application No. 62/533,781, filed on Jul. 18, 2017.

(51) Int. Cl. F27D 17/00; F27B 3/08; F27D 1/12; F27D 1/18

(52) U.S. Cl. CPC F27D 17/003; F27B 3/085; F27D 2001/1825; F27D 1/1816; F27D 17/002; F27D 1/12

(57) ABSTRACT

A duct system of an electric arc furnace includes a plurality of walls each including sinuously winding piping having an inlet and an outlet, and a portion of a first wall of the plurality of walls forming a working platform. The platform is movable between a raised position and a lowered position. In the raised position, the portion of the first wall is disposed in proximate vertical alignment with the remainder of the first wall. In the lowered position, the portion of the first wall is disposed substantially perpendicularly to the remainder of the first wall. The portion of the first wall is sized to occupy a cross-sectional area formed by the plurality of walls such that the portion of the first wall is disposed in close proximity to the other of the plurality of walls.

### RELATED APPLICATIONS

This application claims the benefit of U.S. Provisional Application Ser. No. 62/533,781, filed Jul. 18, 2017, the disclosure of which is hereby incorporated by reference in its entirety.

### FIELD OF THE DISCLOSURE

The present disclosure relates to a duct system, and, in particular, to a duct system for a furnace, oven or process plant.

### BACKGROUND

There are generally several methods for designing and manufacturing water cooled Upper Shells for Electric Arc Furnaces (EAF) and Combustion Chambers, Drop Out Boxes and Ducts for EAF's, Power Plants, Basic Oxygen Furnaces and other types of furnaces, ovens and process plants. In some instances, this equipment is designed in tall vertical runs that can extend 100 feet or more in height.

In most, if not all, cases, the above equipment is installed in difficult to access areas inside the building of a manufacturing facility or is completely integrated plant process equipment. Removing or replacing such equipment can be costly from a labor, equipment and material perspective. Moreover, inspection and repair of these vertical and tall Duct systems can be unsafe unless there is an expensive system of scaffolding, man lifts, or rigging installed on the interior of the duct to protect personnel performing the inspection and maintenance work.

Installing safe scaffolding in a 100-foot tall vertical duct system is both time consuming and expensive. In addition, the inspection and repair workers using scaffolding in these tall, tight and enclosed duct structures are subject to substantially unsafe conditions, in spite of internal scaffolding installation. Potential for falls and injury remain problematic.

Having the ability to minimize the height of scaffolding creates a safer, more economical and quicker method for inspecting and maintaining such Duct systems. This system will result in significant decrease in maintenance and repair downtime. In today's modern processing plants and other manufacturing facilities, it is important that process and equipment up-time is maintained at the highest level possible with little or no downtime. Any scheduled or unscheduled downtime can significantly affect bottom line profit.

### SUMMARY

In a first embodiment of the present disclosure, a duct system of an electric arc furnace includes a plurality of walls each comprising sinuously winding piping having an inlet and an outlet, the plurality of walls each defining a height and a width; and a portion of a first wall of the plurality of walls forming a working platform, the platform being movable between a raised position and a lowered position; wherein, in the raised position, the portion of the first wall is disposed in proximate vertical alignment with the remainder of the first wall; wherein, in the lowered position, the portion of the first wall is disposed substantially perpendicularly to the remainder of the first wall; further wherein, the portion of the first wall is sized to occupy a cross-sectional area formed by the plurality of walls such that the portion of the first wall is disposed in close proximity to the other of the plurality of walls.

In a first example of this embodiment, an articulating actuation system is operably coupled to the portion of the first wall, the articulating actuation system controllably moving the portion between its raised and lowered positions. In a second example, the articulating actuation system comprises a drive operably controlled by an actuator or motor. In a third example, the drive is electric, hydraulic, mechanical, pneumatic or a combination thereof.

In a fourth example of this embodiment, the system may include an interlocking device operably coupled to the portion of the first wall, the interlocking device configured to couple the portion in its raised or lowered position. In a fifth example, the interlocking device comprises a first interlocking device and a second lock interlocking device, the first interlocking device configured to couple the portion of the first wall in the lowered position and the second interlocking device configured to couple the portion in the raised position.

In a sixth example, the system may include a supply line for supplying a cooling liquid from a reservoir to the inlet of the piping of each wall; and a return line fluidly coupled to the outlet of the piping of each wall and the reservoir. In a seventh example, an articulating actuation system is operably coupled to the portion of the first wall for controllably moving the portion between its raised and lowered positions, the articulating actuation system comprising a shaft operably coupled to the portion of the first wall; and a drive actuator for rotatably driving the shaft. In an eighth example, the drive actuator comprises a rod reciprocally driven between an extended position and a retracted position; and a link is coupled between an end of the rod and the shaft; further wherein, in the extended position the portion is in its raised position, and in the retracted position the portion is in its lowered position.

In a ninth example, the shaft forms a supply line for supplying cooling liquid from a reservoir to the inlet of the sinuously winding piping of the first wall. In a tenth example, the plurality of walls comprises steel pipe, AmeriAntiSlag® steel pipe, bronze alloy pipe, nickel alloy or nickel coated steel pipe.

In another embodiment of the present disclosure, a duct system of an electric arc furnace includes a plurality of walls forming an interior of the system, where each of the plurality of walls comprises sinuously winding piping; and a first platform formed at a first location in a first wall of the plurality of walls, the first platform being movable between a raised position and a lowered position; a second platform formed at a second location in the first wall, the second platform being movable between a raised position and a lowered position, where the first location is different from the second position; wherein, in the raised position, the first and second platforms are disposed in proximate vertical alignment with the remainder of the first wall; wherein, in the lowered position, the first and second platforms are disposed substantially perpendicularly to the remainder of the first wall; further wherein, the first and second platforms are sized to occupy a cross-sectional area of the interior such that in the lowered position the first and second platforms are disposed in close proximity to the other of the plurality of walls.

In a first example of this disclosure, the first and second platforms comprise an inner surface and an outer surface, the inner surface configured to be exposed to hot gases and debris in the interior of the system; in the lowered position, the outer surface forms a top working surface and the inner surface is oriented downwardly. In a second example, a seal is formed around outer edges of the first and second platforms in the raised position. In a third example, an articulating actuation system is operably coupled to the first or second platform, the articulating actuation system controllably moving the first or second platform between its raised and lowered positions.

In a fourth example, the articulating actuation system comprises a drive operably controlled by an actuator or motor. In a fifth example, an interlocking device is operably coupled to the first or second platform, the interlocking device configured to couple the first or second platform in its raised or lowered position. In a sixth example, the interlocking device comprises a first interlocking device and a second lock interlocking device, the first interlocking device configured to couple the first or second platform in the lowered position and the second interlocking device configured to couple the first or second platform in the raised position. In another example, the articulating actuation system comprises a shaft operably coupled to the first or second platform, the shaft forms a supply line for supplying cooling liquid from a reservoir to the sinuously winding piping of the first wall.

In a further embodiment of the present disclosure, a duct system of an electric arc furnace includes a plurality of walls each comprising sinuously winding piping having an inlet and an outlet, the plurality of walls each defining a height and a width; a portion of a first wall of the plurality of walls forming a working platform, the platform being movable between a raised position and a lowered position; an articulating actuation system operably coupled to the portion of the first wall, the articulating actuation system controllably moving the portion between its raised and lowered positions; and a control system operably controlling the articulating actuation system; wherein, in the raised position, the portion of the first wall is disposed in proximate vertical alignment with the remainder of the first wall; wherein, in the lowered position, the portion of the first wall is disposed substantially perpendicularly to the remainder of the first wall.

### BRIEF DESCRIPTION OF THE DRAWINGS

The above-mentioned aspects of the present disclosure and the manner of obtaining them will become more apparent and the disclosure itself will be better understood by reference to the following description of the embodiments of the disclosure, taken in conjunction with the accompanying drawings, wherein:

FIG. 1 is a schematic view of a twin shell electric arc furnace with a drop box system;

FIG. 2 is a schematic view of an electric arc furnace off gas system with working platform locations;

FIG. 3 is a front schematic view of the drop out box of FIG. 1 including a large panel liquid-cooled structure;

FIG. 4A is a schematic of a drop out box of an electric arc furnace having a plurality of modular panels including a water cooled element utilized as a working platform;

FIG. 4B is a schematic of the drop out box of FIG. 4A with a working platform in its substantially vertical orientation; and

FIG. 4C is a schematic of the drop out box of FIG. 4A with the working platform in its substantially horizontal orientation.

FIG. 5 is a perspective view of a duct system with integrated working platforms;

FIG. 6 is another partial perspective view of the duct system of FIG. 5 with interlocking devices;

FIG. 7 is the duct system of FIG. 5 having a working platform in a lowered position;

FIG. 8 is a partial perspective view of the duct system with an integrated working platform in a lowered position and its interlock system;

FIG. 9 is a top view of the duct system of FIG. 8;

FIG. 10 is a schematic of one embodiment of an AmeriAntiSlag® Technology extruded pipe for use as an integrated working platform; and

FIG. 11 is a cross-sectional schematic of a steel-making furnace.

Corresponding reference numerals are used to indicate corresponding parts throughout the several views.

### DETAILED DESCRIPTION

The embodiments of the present disclosure described herein are not intended to be exhaustive or to limit the disclosure to the precise forms disclosed in the following detailed description. Rather, the embodiments are chosen and described so that others skilled in the art appreciate and understand the principles and practices of the present disclosure.

In the process industry inspection, repairs and maintenance of electric arc furnaces, off-gas ducts, combustion chambers, drop out boxes, water walls, etc. that rise vertically to heights exceeding 100 feet can be challenging, time consuming and require significant prior planning. In order to make inspections or repairs on such structures, it is necessary to install scaffolding and rigging or use man lifts inside the tight, oxygen-deficient confined space typical of this equipment. This can create potential safety issues working at those heights in such confined spaces for maintenance personnel.

The present disclosure relates to an electric arc furnace, but is applicable to various equipment and industries. Moreover, the present disclosure relates to a method for improving equipment design, manufacture, operation, maintenance and longevity.

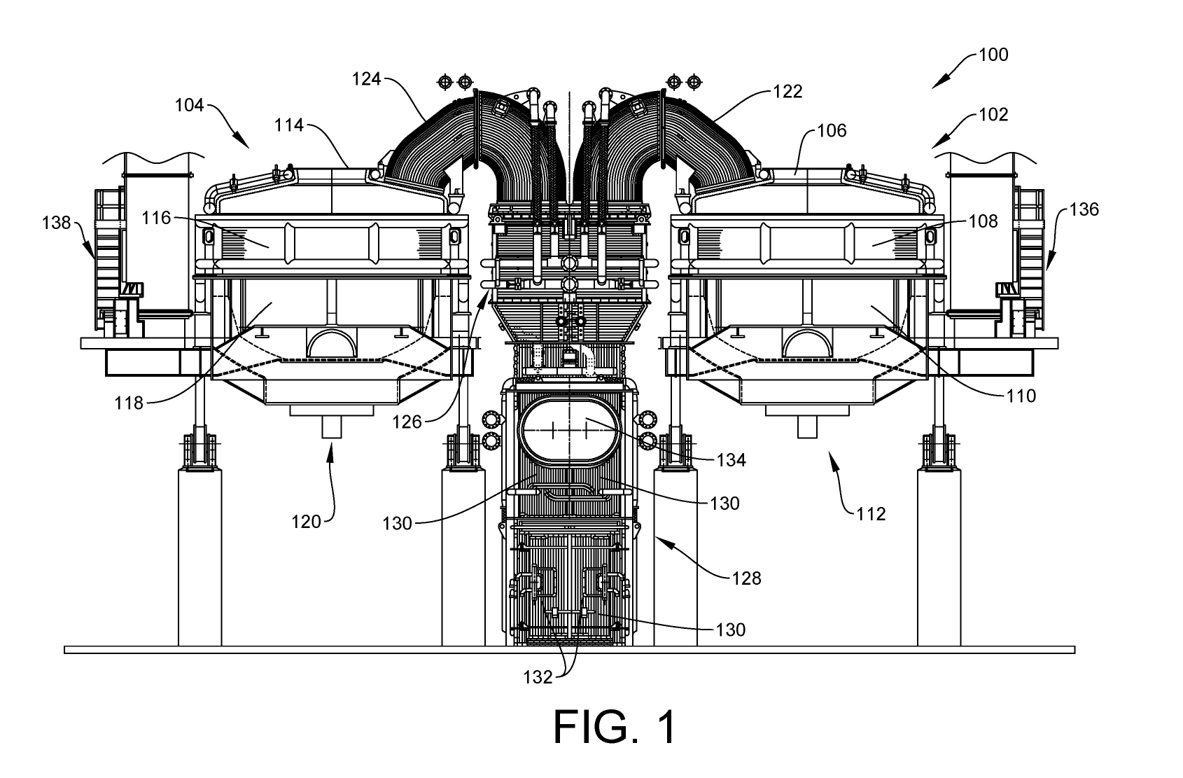

An example of an EAF Upper Shell is shown in FIG. 1 of the present disclosure, where the EAF is shown as a dual or twin shell furnace 100 having a first furnace system 102 and a second furnace system 104. Although not shown, both furnace systems may share a single electric or power system including one or more electrodes. The first furnace system 102 is shown including an upper roof structure 106, an upper shell 108 formed by a frame and liquid-cooled panels, and a first hearth 110. A first platform system 136 may be used to access the first furnace system 102 to perform maintenance and repairs. Similarly, the second furnace system 104 may include a second roof structure 114, a second upper shell 116, and a second hearth 118. A second platform system 138 may be used to access the second furnace system 104 to perform maintenance and repairs. A first tapping assembly 112 may be associated with the first furnace system 102 as is commonly known in the industry, and a second tapping assembly 120 may be associated with the second furnace system 104.

In the embodiment of FIG. 1, the conventional first and second EAF upper shells 108, 116 may be commonly referred to as a structure manufactured from a plate, large diameter pipe and the combination of plate and pipe that supports water cooled panels that are suspended on the inner diameter of the top ring of the upper shell. The water cooled sidewall panels may be suspended using a top plate flange, interconnected flanges, T-bars, pins or brackets (not shown) on the exterior cold face of the panels all of which attach to the respective brackets on the upper shell. One disadvantage of this design is the difficulty to remove and replace the sidewall panels when an unscheduled damage or downtime is experienced. Often, repairs of these sidewall panels require personnel to access the panels from the interior of the upper shell, thereby resulting in significant downtime and loss of productivity.

Returning to FIG. 1, fumes and hot gases may exit the respective furnace systems an evacuation system. As shown, fumes may exit the first furnace system 102 via a first elbow exhaust 122 and enter a central exhaust chamber 126. Likewise, fumes and hot gases exiting the second furnace system 104 may do so via a second elbow exhaust 124 and enter the central exhaust chamber 126. The fumes exiting the furnace systems may flow at a high velocity through the respective elbows, but as the fumes reach the exhaust chamber 126, the diameter of the chamber 126 is greater than that of each elbow thereby resulting in particulates such as dust and other heavier debris to “fall out” of the gas stream and collect in a drop box system 128 as shown in FIG. 1. The drop out box system 128 may include a door or pair of doors 132 to allow a utility vehicle, tractor or loader to enter and remove the dust particles and other particulates therefrom. The fumes and other gases may exit the chamber 126 and drop out box system 128 through a passage 134 to a backhouse, as is known in the art.

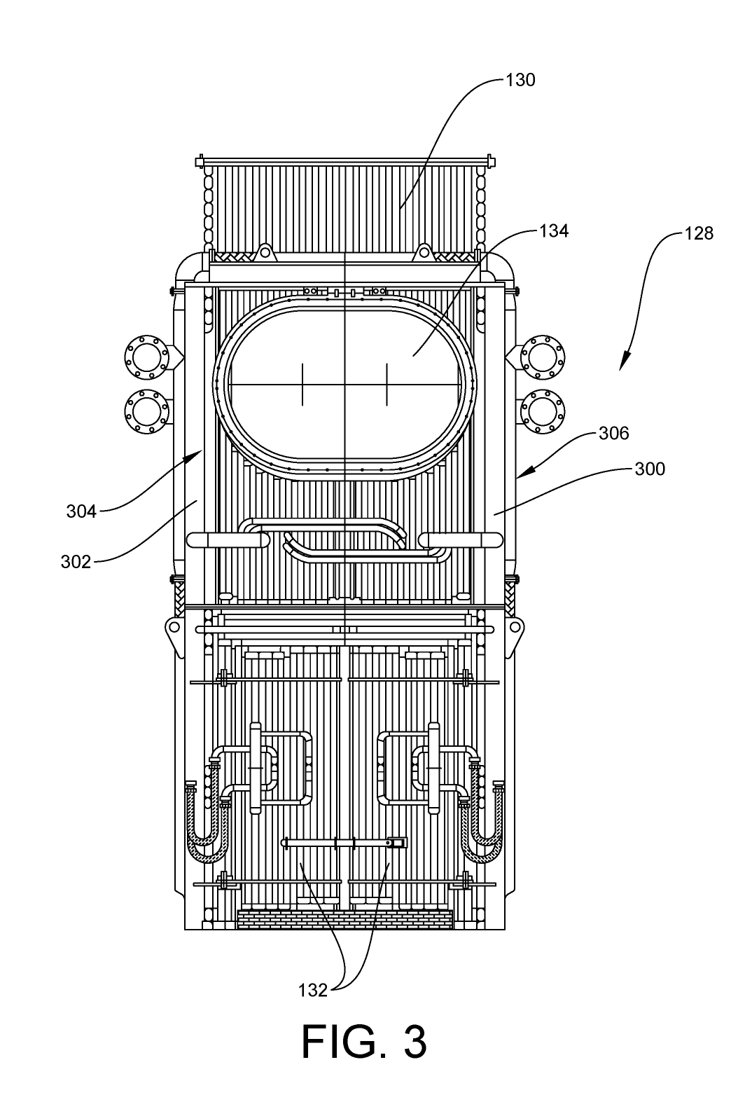

The conventional combustion chamber and drop out box 128 shown in FIG. 1 includes a group of water cooled wall and roof panels 130, configured to the required geometry that are bolted together. In FIG. 3, main water supply and return lines 300, 302 respectively are welded to each panel 130 and interconnected between panels 130. Damaged panels require complete disassembly of the panels and header systems for replacement. Likewise, they can also be designed as a monolithic structure manufactured with pipe or plate having all supply and return piping attached to the outer walls of the equipment. In this illustrated design, the entire device must be removed in the event of incidental damage. Further, access to disassemble or repair damaged panels is from the inside or interior of the chamber or drop out box. Thus, the entire system is shut down in order for the repairs or replacement work to be carried out, thereby causing significant downtime and loss of productivity.

Although the present disclosure is directed more towards the use of modular or cassette-style water cooled wall and roof panels for a combustion chamber, drop out box or other type of enclosure, the principles and teachings thereof may also apply to an EAF. Thus, the following description of an EAF is provided such that these principles and teachings may be applied thereto.

In an electric arc furnace (EAF), a portion above a hearth or smelting area must be protected against the high internal temperatures of the furnace. The EAF vessel wall, cover or roof and duct work are particularly at risk from massive thermal, chemical, and mechanical stresses caused by charging the steel. Such stresses greatly limit the operational life of the furnace. The EAF is generally designed and fabricated as a welded steel structure which is protected against the high temperatures inside the furnace vessel by a refractory lining and water cooled panels. Water-cooled roof panels and water-cooled sidewall panels are located in portions of the furnace vessel above the melting/smelting area of the furnace.

In addition, furnace off-gas ducts are also comprised of a plurality of pipe around its circumference that protect the ductwork from the high temperatures and caustic gases produced during furnace operation. Existing water-cooled panels and ducts are made both with various grades and types of plates and pipes. Using water-cooled panels reduces refractory costs, enables steel makers to operate each furnace for a greater number of heats and enables the furnaces to operate at increased levels of power and chemical energy input. Such panels are designed to incorporate a plurality of pipes in serpentine fashion and hung on the inside wall of the electric arc furnace above the hearth, thereby forming a cooling surface between the interior and the furnace wall.

It is important to maintain a layer of slag on the hot side of the water cooled panels to protect the panels from thermal and arcing degradation during normal furnace operation. Slag cups, slag bars, slag pins and specially designed extruded pipe with splines on the hot side surface of the pipe may be used to retain splattered slag on the hot side surface of the panels. Slag solidifies on the pipes, forming an insulation barrier between the molten iron material and the cooling pipes and, consequently, the wall of the furnace.

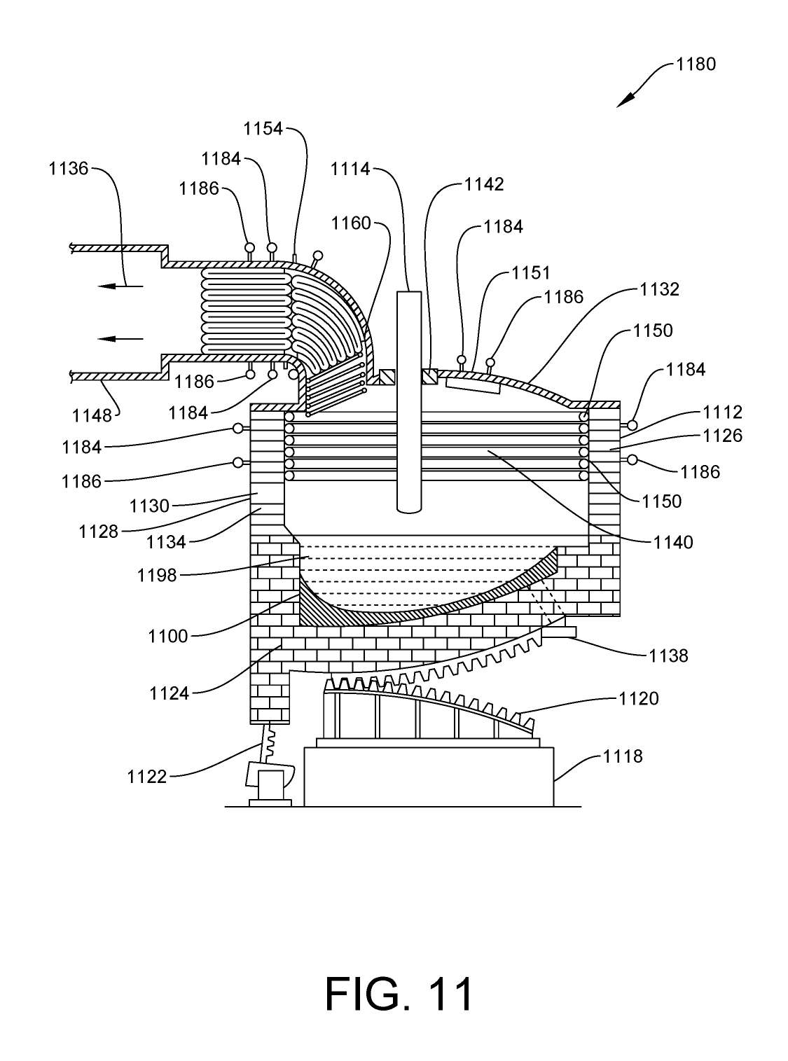

Referring to FIG. 11, one embodiment of a furnace is illustrated as an EAF type furnace 1180. While the EAF is disclosed as one example, it is understood the principles and teachings of the present disclosure may be readily applied in a basic oxygen furnace (BOF) and the like. In FIG. 11, an EAF 1180 may include a furnace shell 1112, a plurality of electrodes 1114, an exhaust system 1116, a working platform 1118, a rocker tilting mechanism 1120, a tilt cylinder 1122, and an off gas chamber. The furnace shell 1112 may be movably disposed upon the rocker tilt 1120 or other tilting mechanism. Further, the rocker tilt 1120 may be powered by the tilt cylinder 1122. The rocker tilt 1120 may also be further secured upon the working platform 1118.

The furnace shell 1112 may include a dished hearth 1124, a generally cylindrical side wall 1126, a spout 1128, a spout door 1130, and a general cylindrical circular roof 1132. The spout 1128 and spout door 1130 are located on one side of the cylindrical side wall 1126. In the open position, the spout 1128 may allow intruding air 1134 to enter the hearth 1124 and partially burn gasses 1136 produced from smelting. The hearth 1124 is formed of a suitable refractory material. At one end of the hearth 1124 is a pouring box having a tap means 1138 at its lower end. During a melting operation, the tap means 1138 is closed by a refractory plug, or a slidable gate. Thereafter, the furnace shell 1112 is tilted, the tap means 1138 is unplugged, or open and molten metal is poured into a teeming ladle, tundish, or other device, as desired.

The inside wall 1126 of the furnace shell 1112 may be fitted with water cooled panels 1140 of sinuously winding piping 1150. The panels, in effect serve as an interior wall in the furnace 1180. The manifolds, which supply cool water and a return, are in fluid communication with the panels 1140. Typically, the manifolds are positioned peripherally in a fashion similar to the illustrated exhaust ducts 1144.

The heat exchanger system 1110 produces a more efficient operation and prolongs the operation life of the EAF furnace 1110. In one illustrative embodiment, the panels 1140 may be assembled such that the sinuously winding piping has a generally horizontal orientation. The piping 1150 can be linked with a linkage or have a base that is mounted to the wall. Alternatively, the panels 1140 can be mounted such that the sinuously winding piping 1150 has a generally vertical orientation. The upper ends of the panels 1140 may define a circular rim at the upper margin of the side wall 1126 portion of the furnace 1180.

The heat exchanger system 1110 can be fitted to the roof 1132 of the furnace 1180, wherein the water cooled panels 1140 have a curvature that substantially follows the domed contour of the roof 1132. The heat exchanger system 1110 may be deployed on the inside of side wall 1126 of the furnace 1180, the roof 1132 and the entrance of the exhaust system 1116, as well as throughout the exhaust system 1116. As such, the heat exchanger system 1110 can protect the furnace and cools the hot waste gasses 1136 as they are ducted to a bag house or other filtering and air treatment facilities, where dust is collected and the gasses are vented to the atmosphere.

In operation, hot waste gasses 1136, dust and fumes are removed from the hearth 1124 through a vent 1146 in the furnace shell 1112. The vent 1146 may be in communication with an exhaust system.

The panel 1140 can have a plurality of axially arranged pipes 1150. U-shaped elbows can connect adjacent sectional lengths of piping or pipes 1150 together to form a continuous piping system. Linkages and the like that additionally serve as spacers may be between adjacent pipes 1150, and they provide structural integrity of the panel 1140 and are determinative of curvature to the panel 1140.

The heat exchange system or heat exchanger 1110 may include at least one panel of the sinuously winding piping 1150 having an inlet (not shown) and an outlet (not shown), an input manifold in fluid communication with the inlet of the at least one panel, an-output manifold in fluid communication with the outlet of the at least one panel, and a cooling fluid flowing through the piping 1150. The heat exchanger system 1110 cools hot fume gasses 1136 and dust that is being evacuated from the metallurgical furnace 180 and its supporting components. The piping is an assemblage of sectional lengths of connected tubes mounted side-by-side, wherein the connected tubes are secured to each other with the linkage, therein forming the at least one panel 1150.

It has been determined that one illustrative and desirable composition for fabricating the piping 1150 is of an aluminum bronze alloy. Aluminum bronze alloys have been found to have a higher than expected thermal conductivity, resistance to etching by the stream of hot gasses (modulus of elasticity), and good resistance to oxidation. Thus, the operational life of the heat exchanger is extended. Corrosion and erosion of the heat exchanger and related components is reduced, when they are fabricated with aluminum bronze. Aluminum bronze has thermal conductivity that is 41% higher than P22 (about 96% Fe, 0.1% C, 0.45% Mn, 2.65% Cr, 0.93% Mo) and 30.4% than carbon steel (A106B). The heat exchangers fabricated using aluminum bronze and alloys thereof are more efficient, and have a longer operational life than furnace constructed of refractive materials and or other metal alloys.

It has also been determined that the piping 1150 may be extruded, and that extruding may help the piping resist corrosion, erosion, pressure, and thermal stress. The piping can be curved or bent to match the curvature of a wall to which it is being attached, if so needed. More typically, the individual sections of piping are secured to each other with an angled linkage such that the resulting panel has a curvature that is comparable to the curvature of the wall.

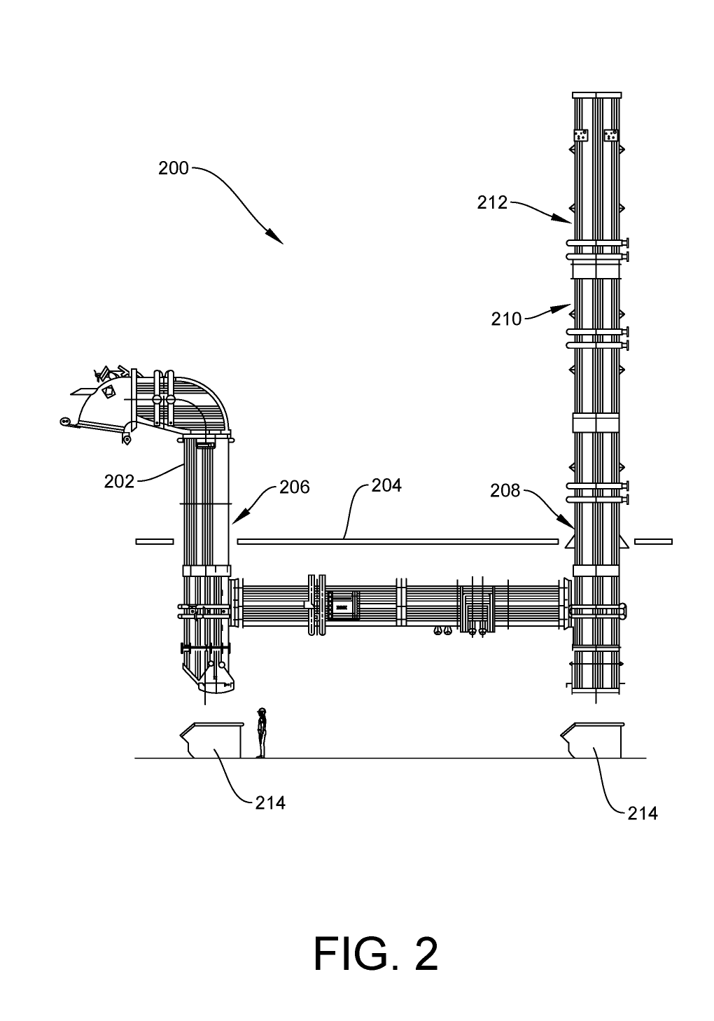

In FIG. 2, one embodiment of an electric arc furnace off gas system 200 is shown. The duct system 200 is shown including a plurality of walls forming an enclosure through which hot gases, air, debris, etc. may pass. In this example, debris, dust and other particulates may be released and collected from an air stream flowing through the system 200 via one or more collection boxes 214.

As shown, the duct system 200 may include vertical sections that extend to extreme heights such as 100 feet or higher. In these locations, a working platform is needed to perform maintenance and repair. In FIG. 2, the system 200 may include a first location 206, a second location 208, a third location 210, and a fourth location 212 at which working platforms may be needed to perform work. Each location is at a height that is greater or above a mezzanine level 204 of the system. In some instances, a worker or maintenance personnel may access the mezzanine level 204 without trouble, but heights above the mezzanine level 204 can be potentially hazardous. Similarly, in FIG. 3, a first location 304 and a second location 306 require a working platform to perform maintenance, and conventionally this is problematic due to the height at both locations.

As previously described, working at these heights can prove challenging and time consuming. In some instances, it can be difficult to provide completely safe conditions. Thus, this disclosure seeks improvements to currently existing platforms to provide safer and less expensive options. Moreover, the present disclosure provides one or more embodiments of designing working platforms into the walls of vertical duct systems, combustion chambers, drop out boxes, water walls, etc.

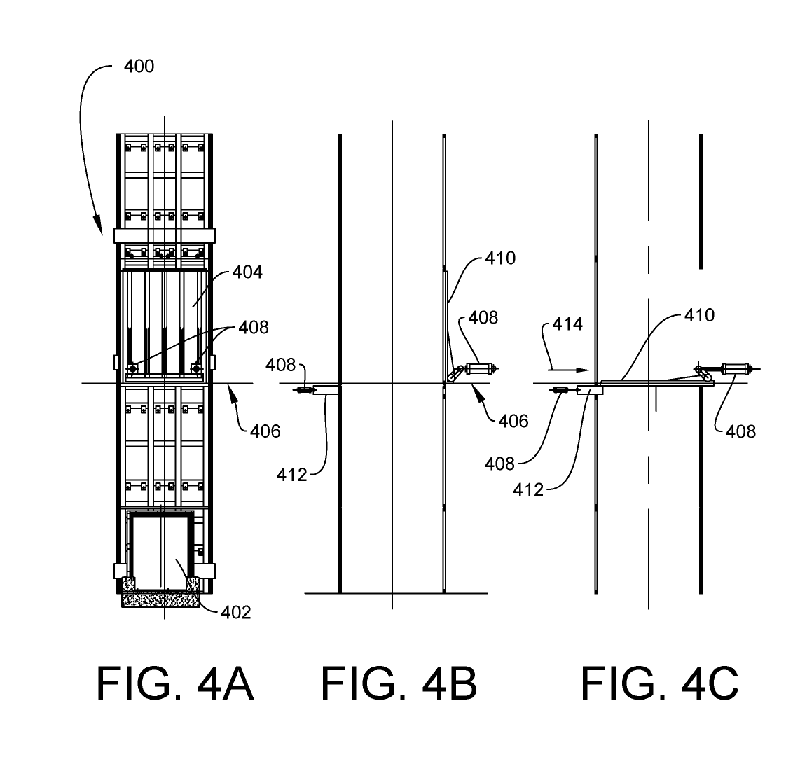

In one embodiment, a duct or equipment wall segment may be sized to be the same as an internal cross-section of the device. This may provide a safer work zone with a reduced possibility of a worker falling through a wider space or opening. The wall segment may be an integrated part of the water-cooled wall. An example of this is shown in FIG. 4.

As shown, a drop out box 400 or other enclosure is shown. The drop out box 400 may be 40′ or higher, and it may include the type of support structure and water cooled panels 404 as described herein. The drop out box 400 may include an entrance 402 similar to the doors 132 of FIG. 1. In this example, the drop out box 400 may include one more levels or floors 406 associated therewith. In FIG. 4, for example, a mezzanine level 406 is shown. In some cases, it can be difficult to reach a panel 404 located above the mezzanine level 406. While a ladder may be useful, it may only reach so high. Scaffolding or other lifts may not fit within the enclosure, where the cross-sectional area inside the drop out box 400 may be tight and lack sufficient air flow.

Thus, to reach the higher elevations within the enclosure 400, one of a plurality of panels 404 may be used to form a working platform 410 at the mezzanine level 406 or any other level. In FIGS. 4B and 4C, the platform 410 may be controllably actuated by a cylinder or actuator 408 between a raised position (FIG. 4B) and a lowered position (FIG. 4C). In the lowered position, the panel 410 may be substantially horizontal and held in place by a latching system 412, as will be described in further detail below. The latching system 412 may be controlled by a mechanical, hydraulic, electric, electro-mechanical, pneumatic, or any other type of actuator 408.

The same may be true for controlling the working platform 410. In the lowered position of FIG. 4C, a ladder or other device may be placed on the platform 410 to reach a water cooled panel located above the mezzanine level 400. Other types of systems for controlling movement of the floor panel are possible with this system, and the aforementioned actuator is only such example. The same is true for controlling the latching system 412. Any known system for coupling and holding the floor panel in its lowered position may be used in this system.

The working platform 410 of FIG. 4 may form or function as the aforementioned water-cooled segment, and the platform may be manufactured from a plurality of pipe, plate, or plate/channels in conjunction with many material types that provide optimal thermal conductivity, water pressure drop, and resistance to the hot and dirty gases which are emitted during process operations. The water-cooled segment's “cold side” may be used as a safe working platform for personnel to inspect, maintain and repair the vertical system. In other words, the exterior side of the working platform 410 is referred to as the “cold side” since it is not exposed to hot gases and the like on the interior of the enclosure 400. The opposite side, or “hot side” of the working platform faces downwardly in FIG. 4C. Thus, the “cold side” or exterior surface of the working platform 410 functions as the top, working surface when the working platform 410 is in its horizontal working position.

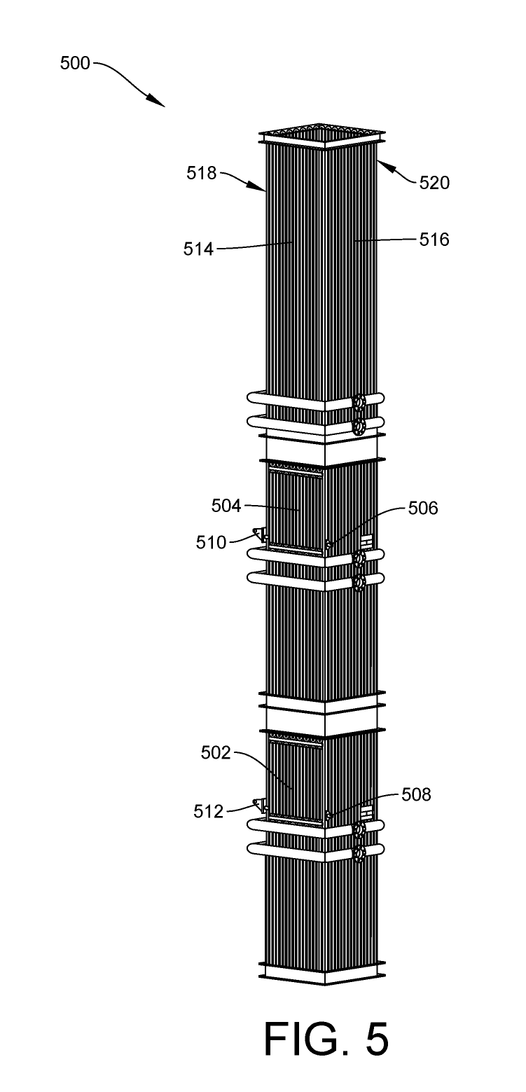

In FIG. 5, a duct system or drop out box system 500 is shown. The system 500 includes a plurality of walls formed by water cooled panels comprising sinuously winding piping, as shown. Each panel may be fluidly coupled to an inlet and an outlet at a header pipe. The inlet and outlet may correspond with the supply line and return line of FIG. 3. The supply line or header may be coupled to a reservoir of cooling water or other liquid, which is pumped through the various lines and each of the plurality of water cooled panels to provide cooling thereto. With hot gases, debris and dust passing through the interior of the system 500, the cooling panels provide stability and robustness to the overall system 500.

The system 500 is shown being arranged as a vertically-extending duct or system that is capable of reaching extreme heights, e.g., 40′ or greater. In this illustrated embodiment, a first working platform, or first platform 502, and a second working platform, or second platform 504, may be integrally formed therein. Each platform is integrally formed or coupled to one of the plurality of walls forming the system 500. As shown, the system 500 includes a first wall 514, a second wall 516, a third wall 518, and a fourth wall 520. Each of the four walls defines an internal cross-section of the enclosure. Each working platform may include a height and width that corresponds to the internal cross-section of the enclosure. In this way, the working platform forms a safe and secure working surface without any sizeable gaps or openings between it and the surrounding walls through which a worker could fall or be injured. In other words, the size of the working platform is designed to correspond with the internal cross-section so as to form a floor at its location from which work, repair, maintenance, etc. can be safely performed.

The first working platform 502 is located on the first wall 514, and it is rotatably mounted via a first shaft 508. The first shaft 508 may function as a header or supply pipe in addition to being a drive shaft. In other words, a cooling liquid such as water may be supplied to the shaft 508 for distributing to the sinuously winding piping of the working platform 502. Further, a first actuator 512 may be operably controlled for raising or lowering the working platform 502. In FIG. 5, the working platform 502 is disposed in its raised position.

The second working platform 504 may also be located on the first wall 514, as shown in FIG. 5. The second working platform 504 may be rotatably mounted via a second shaft 506. Like the first shaft 508, the second shaft 506 may function as a header or supply pipe in addition to being a drive shaft. Thus, cooling liquid may be supplied from a reservoir to the second shaft 506, which is coupled to an inlet of the sinuously winding piping of the second platform 504. Moreover, a second actuator 510 may operably control the second platform 504 between its raised and lowered positions.

In FIG. 5, the water-cooled elements or working platforms 502, 504 may be fastened to a duct and act as the duct wall during normal operation of the drop out box system 500. However, when inspection or repairs are needed, the platform portion 502, 504 of the duct wall can be rotated or pivoted into the interior of the modular structure and locked into a horizontal position to act as a working platform. The element or platform portion may also include the drive shaft, bearings, rotating water valves and a mechanical actuation system (e.g., a hydraulic cylinder, motor, etc.) to move the element or platform portion into and out of a horizontal position or orientation.

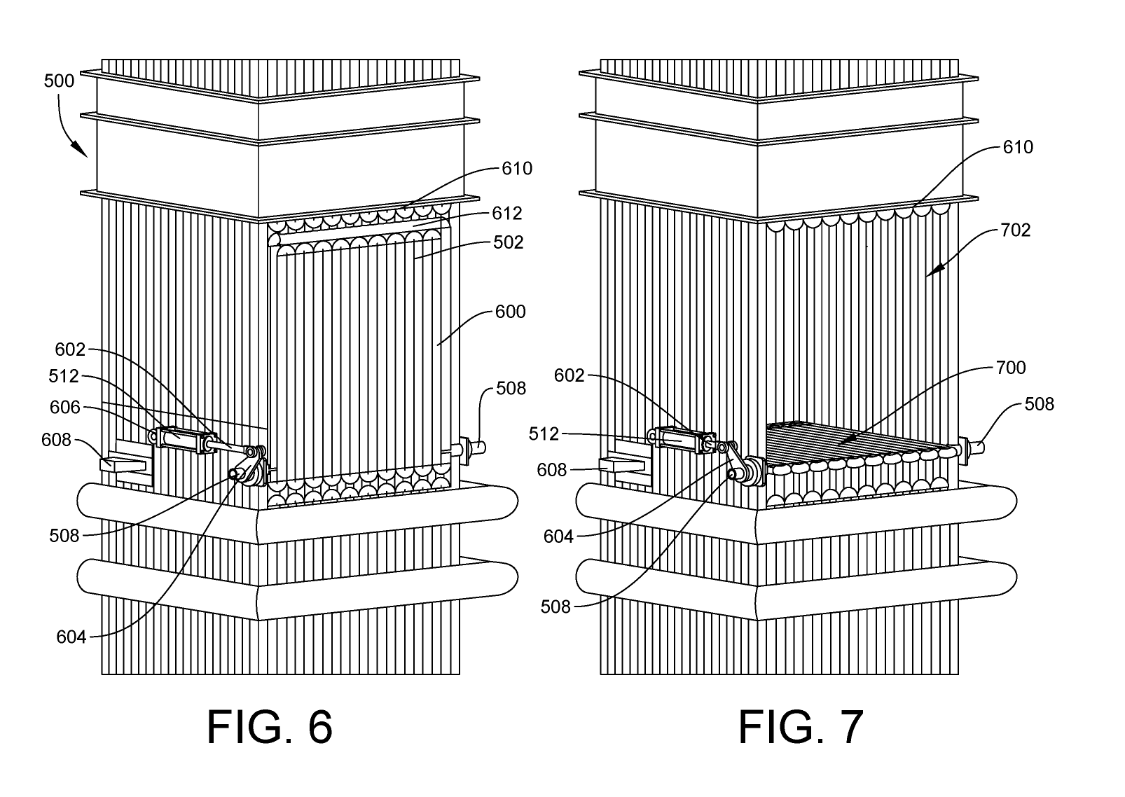

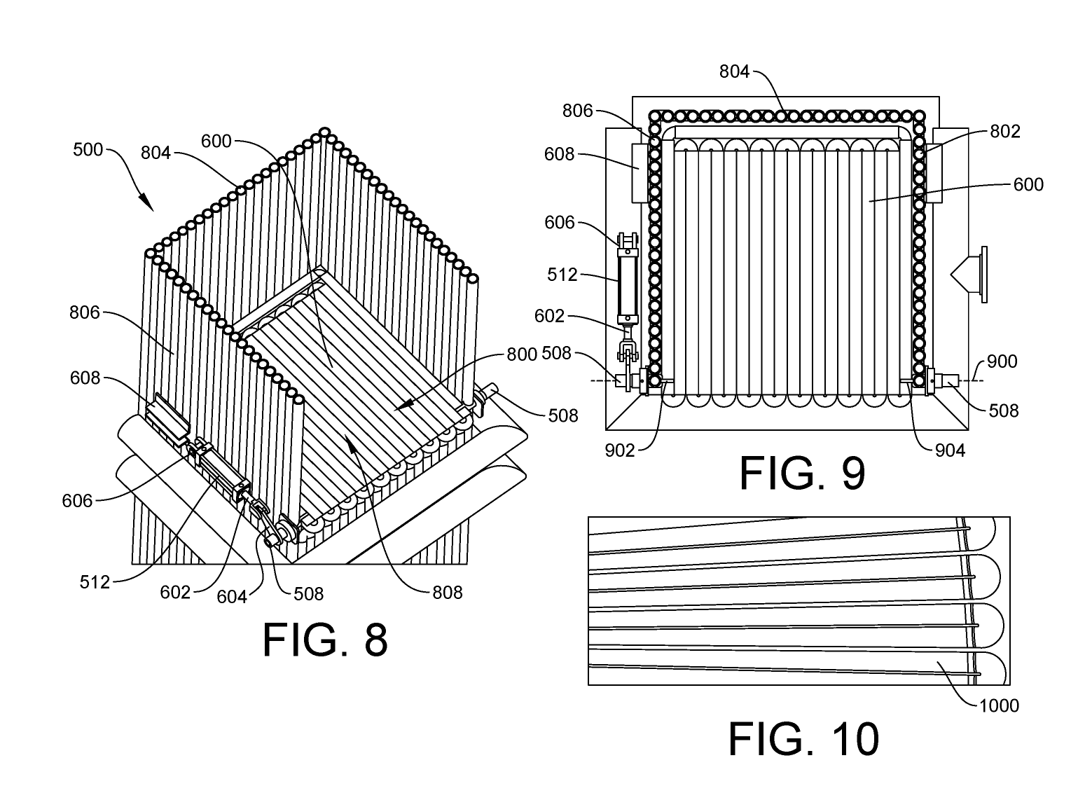

In FIGS. 6-9, another embodiment of the present disclosure is illustrated. In this embodiment, a duct system or drop out box system 500 comprising a plurality of vertical walls to from an enclosure is shown. Here the enclosure includes a first side 802, a second side 804, a third side 806, and a fourth side 808. The size and shape of the enclosure may differ and include fewer or additional sides. In any event, each side is formed by a modular water-cooled wall including sinuously winding piping having an inlet (not shown) coupled to a supply header and an outlet (not shown) coupled to a return header. The supply header (not shown) may be fluidly coupled to a reservoir of cooling liquid where the cooling liquid is pumped through the supply header and fed to each inlet of the plurality of walls. Each wall may include its own inlet, or alternatively, one or more of the walls may share an inlet. Likewise, each wall may include its own outlet which is fluidly coupled to a return header. Alternatively, one or more walls may share an outlet. As the cooling liquid circulates through the sinuously winding piping of each wall, it flows through the outlet and into the return header. From the return header, the liquid may flow back to the reservoir. Thus, a closed-loop flow control system may be established for cooling the walls of the enclosure.

In FIG. 6, the first working platform 502 of FIG. 5 is shown integrally formed in a portion of the side wall of the system 500. The platform 502 is formed by a sinuously winding piping 600. A first drive shaft 508 may be operably controlled by a first actuator 512. The first actuator 512 may be driven mechanically, electrically, hydraulically, pneumatically, a combination thereof, or any other known way. The actuator 512 may operably drive a reciprocating rod 602 between an extended position and a retracted position. In FIG. 6, the rod 602 is shown in its extended position, which corresponds with the first platform 502 being in its raised position. In FIG. 7, however, the rod 602 is disposed in its retracted position, which corresponds with the first platform 502 being in its lowered position.

In FIG. 6, a link 604 is shown pivotally coupled between an end of the rod 602 and the drive shaft 508. Thus, as the rod 602 extends and retracts, it operably pivots or swings the link 604 to induce rotational movement to the shaft 508. As such, the rotational movement of the drive shaft 508 about axis 900 causes the first platform 502 to move between its raised and lowered positions.

A drive system 606 may operably power the actuator 512. For instance, an electric or hydraulic motor may function as the drive system 606. However, in this disclosure, other conventional systems may be used as the drive system. In one embodiment of this disclosure, movement of the wall segment or platform may be controlled by a mechanical articulating actuation system. The mechanical articulating actuation system may include drives operably controlled by hydraulic or pneumatic actuators, hydraulic or electric motors, or any other known mechanical, hydraulic, electric, pneumatic system or combination thereof.

In FIG. 6, one or more interlocking devices may be provided. For example, a first interlock device 608 and a second interlock device 610 are shown. The second interlocking device 610 may secure the wall segment or platform 502 in a fixed vertical operating position (FIG. 6), and the first interlocking device 608 can support the wall segment or platform 502 when it is in the horizontal platform working position, as shown in FIG. 7. The interlocking or locking devices may be any combination of a mechanical, hydraulic, pneumatic, electromechanical, automatic, semi-automatic, or manual operating device. Each interlocking device may be activated when the panel is rotated to the vertical or horizontal position. The first interlocking device 608 may further provide a hard mechanical stop for the rotating wall segment to contact or rest on when in the open platform position (FIG. 7). The tips of the interlocking devices may be water-cooled, as needed, to protect them against the hot, dirty off gases inside the enclosure.

The interlocking devices may be designed to have a lock-out/lock-in system and may be checked for positive locking device engagement before personnel access the working platform. A controller or control system (not shown) may utilize sensors and the like to detect the condition of the interlocking devices. A proximity or position sensor (not shown) may be disposed at each location of the interlocking device to detect its position or status. The sensors may then communicate the status or position of each interlocking device to the controller or control system. If an interlocking device is not working properly, the controller or control system may disable the drive system 606 and actuator 512 from moving the working platform 502.

Moreover, the controller or control system may operably control the drive system 606 and actuator 512 to control movement of the working platform. For example, a switch or other control (not shown) may be provided such that a worker or maintenance personnel can send a command to the controller or control system to actuate the drive system 606 and actuator 512. The switch or control may be located remotely from the enclosure, or it may be disposed on an exterior wall of the enclosure.

In FIG. 6, the enclosure is shown with a header 612 located above the working platform 502. In this manner, the shaft 508 may function as either a supply or return line and the header 612 may function as the other. In other words, the cooling liquid may be supplied from the reservoir to either the shaft 508 or header 612, and as the liquid flows through the sinuously winding piping 600, it may exit through an outlet into the other of the shaft 508 or header 612.

The wall segment or working platform 502 may rotate about the shaft 508 so that the panel 502 can used as a working platform to inspect and repair the inside of the structure. As noted, the shaft 508 may also be designed to distribute water supply and receive return water from the wall segment. In this embodiment, rotary valves 902, 904 may be placed on each end of the shaft 508 to allow supply and return water into and out of the water cooled wall segment or platform 502, respectively. Each valve 902, 904 may be manually or automatically controlled. For example, the controller or control system (not shown) may be control the position of each valve 902, 904 to either allow or shut off the flow of cooling liquid.

As also shown in the embodiment of FIGS. 6 and 7, there may be no need for hand rails on the platform 502. This is due to the entire opening of the chamber being covered by the wall segment platform 502. As a result, this can keep maintenance and operating personnel safer and reduces exposure to potential inadvertent falls through openings and such.

Another feature, as shown in FIG. 7, is that the exterior or cooling side 800 of the working platform 502 forms a top surface 700 when the working platform 502 is in its lowered position. This protects the worker from injury due to the hot temperature of the opposite, or inner wall 702. In other words, the inner wall 702 of the platform 502 faces downwardly and thus the worker is not exposed to this surface. Instead, the worker or maintenance personnel may stand and work from the cold side 800 of the working platform 502 (i.e., its exterior side).

The materials of manufacture of the water-cooled wall segment or working platform can be adjusted to match the operating requirements for a specific area of the process equipment. Such materials, for example, may include, steel pipe, AmeriAntiSlag® steel pipe, bronze alloy pipe (e.g., AmeriBronze®, AmeriHVP, etc.), nickel alloy or nickel coated steel pipe, or any new alloy that may be developed for pipe or tube manufacture, casting or extrusion.

One advantage of utilizing AmeriAntiSlag® extruded pipe 1000 as the material for the wall segment or platform is that the AmeriAntiSlag® Pipe includes a flat portion that can be placed or arranged on the cold side of the wall segment. In effect, this may provide a flat work area or surface as compared to the irregular surface that may result with a standard pipe design wall segment. In the event that a standard pipe is used, the cold side of the wall segment may have a separate steel plate backing (not shown) so that there is a clear and unobstructed flat working surface.

The perimeter of the wall segment or working platform, when in the closed, raised position, may be sealed to prevent egress of combustible gases from the operating device and eliminating the ingress of ambient air into the operating device. A seal or gasket may be disposed about the outer perimeter of the working platform or opening formed in the wall to form the sealing function.

The embodiments of the present disclosure provide an improved method of safe and simple access to a small oxygen deficient confined space in ducts, combustion chambers, drop our boxes, water walls, etc. The wide opening of the wall segment decreases the opportunity for personnel to be injured by oxygen-deficient off-gases. The system also improves personnel safety that requires shorter equipment inspection and repair time. Moreover, the system may eliminate the need for high cost and labor limiting man lifts, extensive scaffolding to make inspections and repairs. The system further increases operational up-time, decreased planned and unplanned downtime for duct inspections and repair, and in general lower overall maintenance costs.

While exemplary embodiments incorporating the principles of the present disclosure have been disclosed herein, the present disclosure is not limited to the disclosed embodiments. Instead, this disclosure is intended to cover any variations, uses, or adaptations of the disclosure using its general principles. Further, this application is intended to cover such departures from the present disclosure as come within known or customary practice in the art to which this disclosure pertains and which fall within the limits of the appended claims.

1. A duct system of an electric arc furnace, comprising:
a plurality of walls each comprising sinuously winding piping having an inlet and an outlet, the plurality of walls each defining a height and a width; and
a portion of a first wall of the plurality of walls forming a working platform, the platform being movable between a raised position and a lowered position;
wherein, in the raised position, the portion of the first wall is disposed in proximate vertical alignment with the remainder of the first wall;
wherein, in the lowered position, the portion of the first wall is disposed substantially perpendicularly to the remainder of the first wall;
further wherein, the portion of the first wall is sized to occupy a cross-sectional area formed by the plurality of walls such that the portion of the first wall is disposed in close proximity to the other of the plurality of walls.

2. The duct system of claim 1, further comprising an articulating actuation system operably coupled to the portion of the first wall, the articulating actuation system controllably moving the portion between its raised and lowered positions.

3. The duct system of claim 2, wherein the articulating actuation system comprises a drive operably controlled by an actuator or motor.

4. The duct system of claim 3, wherein the drive is electric, hydraulic, mechanical, pneumatic or a combination thereof.

5. The duct system of claim 1, further comprising an interlocking device operably coupled to the portion of the first wall, the interlocking device configured to couple the portion in its raised or lowered position.

6. The duct system of claim 5, wherein the interlocking device comprises a first interlocking device and a second lock interlocking device, the first interlocking device configured to couple the portion of the first wall in the lowered position and the second interlocking device configured to couple the portion in the raised position.

7. The duct system of claim 1, further comprising:
a supply line for supplying a cooling liquid from a reservoir to the inlet of the piping of each wall; and
a return line fluidly coupled to the outlet of the piping of each wall and the reservoir.

8. The duct system of claim 1, further comprising an articulating actuation system operably coupled to the portion of the first wall for controllably moving the portion between its raised and lowered positions, the articulating actuation system comprising:
a shaft operably coupled to the portion of the first wall; and
a drive actuator for rotatably driving the shaft.

9. The duct system of claim 8, wherein:
the drive actuator comprises a rod reciprocally driven between an extended position and a retracted position; and
a link is coupled between an end of the rod and the shaft;
further wherein, in the extended position the portion is in its raised position, and in the retracted position the portion is in its lowered position.

10. The duct system of claim 8, wherein the shaft forms a supply line for supplying cooling liquid from a reservoir to the inlet of the sinuously winding piping of the first wall.

11. The duct system of claim 1, wherein the plurality of walls comprises steel pipe, AmeriAntiSlag® steel pipe, bronze alloy pipe, nickel alloy or nickel coated steel pipe.

12. A duct system of an electric arc furnace, comprising:
a plurality of walls forming an interior of the system, where each of the plurality of walls comprises sinuously winding piping; and
a first platform formed at a first location in a first wall of the plurality of walls, the first platform being movable between a raised position and a lowered position;
a second platform formed at a second location in the first wall, the second platform being movable between a raised position and a lowered position, where the first location is different from the second position;
wherein, in the raised position, the first and second platforms are disposed in proximate vertical alignment with the remainder of the first wall;
wherein, in the lowered position, the first and second platforms are disposed substantially perpendicularly to the remainder of the first wall;
further wherein, the first and second platforms are sized to occupy a cross-sectional area of the interior such that in the lowered position the first and second platforms are disposed in close proximity to the other of the plurality of walls.

13. The duct system of claim 12, wherein:
the first and second platforms comprise an inner surface and an outer surface, the inner surface configured to be exposed to hot gases and debris in the interior of the system;
in the lowered position, the outer surface forms a top working surface and the inner surface is oriented downwardly.

14. The duct system of claim 13, further comprising a seal formed around outer edges of the first and second platforms in the raised position.

15. The duct system of claim 12, further comprising an articulating actuation system operably coupled to the first or second platform, the articulating actuation system controllably moving the first or second platform between its raised and lowered positions.

16. The duct system of claim 15, wherein the articulating actuation system comprises a drive operably controlled by an actuator or motor.

17. The duct system of claim 15, further comprising an interlocking device operably coupled to the first or second platform, the interlocking device configured to couple the first or second platform in its raised or lowered position.

18. The duct system of claim 17, wherein the interlocking device comprises a first interlocking device and a second lock interlocking device, the first interlocking device configured to couple the first or second platform in the lowered position and the second interlocking device configured to couple the first or second platform in the raised position.

19. The duct system of claim 15, wherein the articulating actuation system comprises a shaft operably coupled to the first or second platform, the shaft forms a supply line for supplying cooling liquid from a reservoir to the sinuously winding piping of the first wall.

20. A duct system of an electric arc furnace, comprising:
a plurality of walls each comprising sinuously winding piping having an inlet and an outlet, the plurality of walls each defining a height and a width;
a portion of a first wall of the plurality of walls forming a working platform, the platform being movable between a raised position and a lowered position;
an articulating actuation system operably coupled to the portion of the first wall, the articulating actuation system controllably moving the portion between its raised and lowered positions; and
a control system operably controlling the articulating actuation system;
wherein, in the raised position, the portion of the first wall is disposed in proximate vertical alignment with the remainder of the first wall;
wherein, in the lowered position, the portion of the first wall is disposed substantially perpendicularly to the remainder of the first wall.
